(19) United States
(12) Patent Application Publication
(10) Pub. No.: US 2024/0339965 A1
(43) Pub. Date: Oct. 10, 2024

(54) SOLAR ARRAY OUTPUT MODEL REFINEMENT

(71) Applicant: Inventus Holdings, LLC, Juno Beach, FL (US)

(72) Inventors: Kristen BRADFORD, Rosemount, MN (US); Brian TORBORG, Eagan, MN (US); Richard ARGENTIERI, Juno Beach, FL (US); Christopher NUNALEE, West Palm Beach, FL (US); Richard WALKER, JR., Lakeville, MN (US)

(21) Appl. No.: 18/298,063

(22) Filed: Apr. 10, 2023

(51) Int. Cl. H02S 50/00; H02S 20/32

(52) U.S. Cl. CPC H02S 50/00; H02S 20/32

(57) ABSTRACT

Systems and methods for training a power production estimating system. A first and a second set of sensor data are collected from a first and a second solar array field, respectively, each having a number of solar cell segments. The first solar array field has a first set of sensors and an area greater than a first area, and the second solar array field has a second set of sensors and an area less than a second area with the first area more than three times the second area. A first and second training set are created from the first set and second set of sensor data, respectively. A prediction model based on the first training set is developed that estimates electrical output produced by the first solar array field and is refined based on modelling of the second solar array field using the second training set.

### FIELD OF THE DISCLOSURE

The present disclosure generally relates to modelling and predicting operational parameters of operating systems, and more particularly to refining models used to predict operational parameters of operating solar energy systems

### BACKGROUND

Predicting the operational parameters of various systems, such as solar energy systems, often employ mathematical models that relate quantities or characteristics of an operating system to other quantities or characteristics of that system. For example, input quantities such as incoming sunlight, sunlight angle, ambient temperature, other quantities, or combinations of these are able to be provided to a mathematical model that is able to process these input quantities to predict estimated output quantities such as output electrical power or total electrical energy production over a period of time.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 illustrates an example solar array and monitoring system, according to an example;

FIG. 2 illustrates a detailed view of the second solar array field and associated monitoring equipment, according to an example;

FIG. 3 illustrates a sensor equipment density chart, according to an example;

FIG. 4 illustrates a solar array model improvement process, according to an example;

FIG. 5 illustrates a tracking pedestal shading determination algorithm; according to an example;

FIG. 6 illustrates a solar farm underperformance recognition model development process, according to an example;

FIG. 7 illustrates a solar farm temperature dependence model adjustment process, according to an example;

FIG. 8 illustrates a bifacial array solar farm estimation model development process, according to an example; and

FIG. 9 illustrates a block diagram illustrating a processor, according to an example.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the disclosed subject matter in virtually any appropriately detailed structure and function. Further, the terms and phrases used herein are not intended to be limiting, but rather, to provide an understandable description.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The below described systems and methods operate to develop, refine, or both develop and refine, computer models of the operations of solar fields, such as solar array fields that consist of a number of photovoltaic solar cells that produce electrical power. Such computer models in some examples receive inputs that represent environmental conditions or equipment conditions or status at various points around the solar array field and produce estimates of predicted electrical output power that is able to be produced by the solar array field given the received parameters.

In an example, the below described systems and methods utilize two solar array fields, a first solar array field that in an example has a conventional density of sensor equipment distributed across the first solar array field, and a second solar array field that is instrumented with a higher density of sensor equipment. In some examples, the second solar array field is able to be contiguous with the first solar array field.

In some examples, the design of the solar cells and their physical structures is similar between these two solar array fields. In such an example, a first computer model operates to predict estimations of the electrical power output of the first solar array field based on the input of the sensors installed on that field, and a second computer model operates to predict estimations of the electrical power output of the second solar array field based on the input of the more densely installed sensors installed on that field. These predicted electrical power outputs are able to be provided to further processing elements, analysis tools, other elements or persons, or combinations of these.

In some examples, processing, analysis, interpretation by other techniques, or combinations of these, of data produced by the more densely deployed sensors in the second solar array field are able to identify small scale effects of physical characteristics of the installation, environment, other factors, or combinations of these, of the second solar array field to the production of electrical energy by solar cells installed therein. Processing, analysis, other techniques, or combination of these are able to determine if there are differences between the output power predicted by the first computer model and the second computer model. The processing, analysis, interpretation by other techniques, or combinations of these, of the data produced by the more densely deployed sensors of the second solar array field are able to provide insights into the operation of models processing data reported by the less densely deployed sensors of the first solar array field. In some examples, these insights are used to improve a model used to predict the electrical output, other operating parameters, or both, of the first solar array field that has a less dense deployment of sensors.

In an example the first solar array field and the second solar array field are located in close proximity to each other. In some examples, the second solar array field is able to be adjacent to the first solar array field. In an example, the second solar array field is able to be created by adding additional sensors to an existing portion of a solar array field, such that the portion with the newly added sensors is the second solar array field and the remainder of that original solar array field is then the first solar array field. In some examples, the first solar array field and the second solar array field are able to be located apart from one another. In an example of a scenario of the first solar array field and the second solar array field being apart from one another, such locations are chosen based upon having similar geographical characteristics, environmental parameters, other characteristics, or combinations of these.

In these examples, the predicted output power of the first computer model or the second computer model is able to be scaled due to differences between the capacities of these two solar array fields. In an example, the first computer model is refined based on determined differences between the output of the first computer model and the second computer model, where the output of the second computer model is scaled to accommodate differences in sizes between the first solar array field and the second solar array field, in order to improve the accuracy of the first computer model not withstanding its less dense arrangement of sensors. The refined first computer model is then able to be used in similar solar array fields, or areas being considered for potential solar array fields, with appropriate output scaling to better predict the power output of those similar solar array fields or potential solar array fields.

The below described systems and methods are able to operate with solar cells that are mounted on either fixed-tilt and tracking solar cells pedestals. Fixed-tilt pedestals in an example mount solar cells with a fixed orientation relative to the ground. Tracking solar cell pedestals in an example include components to move the orientation of solar cells mounted thereon to so as to more closely align with the position of the sun. Tracking solar cell pedestals in some examples do not exactly position the solar cell to maintain a perpendicular orientation with the sun based upon, for example, limitations in the possible movement of the pedestal. In an example, solar cells mounted on tracking solar cell pedestals are referred to as tracking solar cells.

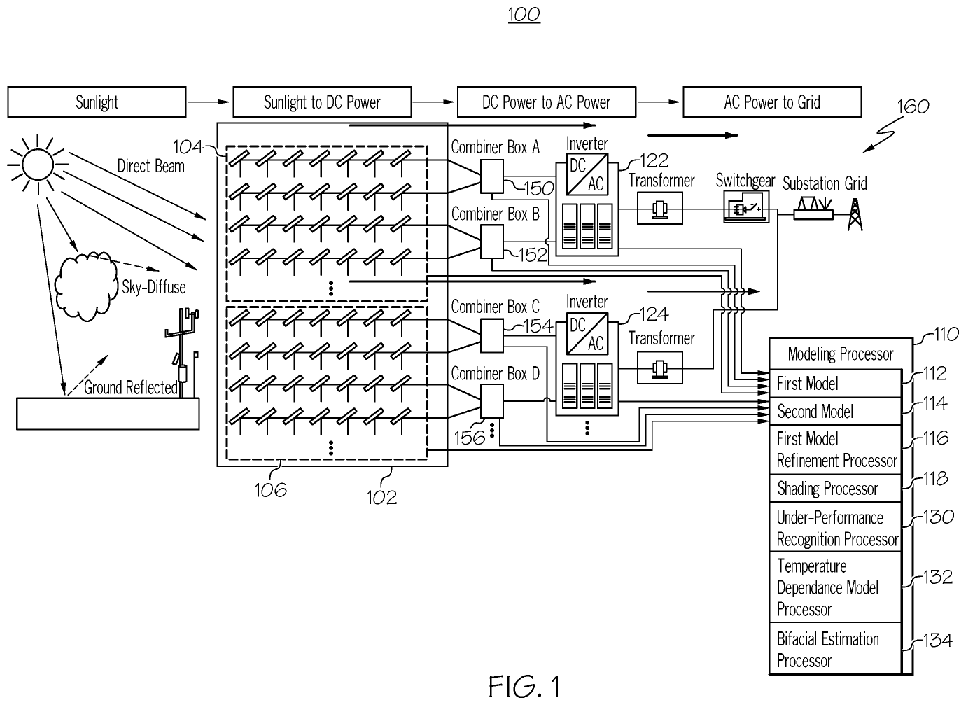

FIG. 1 illustrates an example solar array and monitoring system 100, according to an example. The example solar array and monitoring system 100 depicts an example of a power production estimation model training system. The example solar array and monitoring system 100 depicts a solar array 102 that is divided into two solar array fields. The solar array 102 in the illustrated example includes a first solar array field 104 that has a conventional density of sensor equipment (not shown) distributed across the first solar array field 104, and a second solar array field 106 that is instrumented with a higher density of sensor equipment (not shown).

In this illustrated example, the second solar array field 106 is contiguous with the first solar array field 104 and forms the solar array 102. In further examples, the second solar array field 106 is able to be separated from the first solar array field 104. The design of the solar cells and their physical structures in the first solar array field 104 is similar to the solar cells and their physical structures in the second solar array field 106. In further examples, the design and configuration of solar cells and physical structures in the first solar array field 104 is able to differ from that in the second solar array field 106. In some examples, the first solar array field 104 has an area that is greater than a first area size, and the second solar array field 106 has an area that is less than a second area size, where the first area size is at least three (3) times the area of the second area size. In an example, the first area size is greater than 0.2 square Kilometers, and the second area size is less than 0.06 square Kilometers.

The example solar array and monitoring system 100 includes sensors to monitor and measure electrical current generated by components of the solar array 102. In the illustrated example, a current combiner box A 150 is depicted as being wired to receive and combine electrical current generated by the top two rows of the first solar array field 104, and a current combiner box B 152 is depicted as being wired to receive and combine electrical current generated by the next two rows of the first solar array field 104. In general, a current combiner box is able to be connected to any number of rows of solar cells, such as could be determined based upon the electrical current capacity of that current combiner box. The ellipses beneath these components indicate that these components are replicated in various examples. The electrical current produced by the current combiner box A 150, current combiner box B 152, and further current combiner boxes (not shown) associated with the first solar array field 104 is provided to a first inverter 122 for conversion into electrical power suitable to be provided to the electrical grid 160 in this example.

In the illustrated example, the current combiner box A 150, current combiner box B 152, other current combiner boxes associated with the first solar array field 104, and the first inverter 122 each include electrical current meters to measure the total electrical current being processed by each of those respective components. The reported electrical current produced by the solar array 102, including the portions of the total electrical current as measured by current combiner box A 150, current combiner box B 152, other current combiner boxes associated with the first solar array field 104, and the total electrical current as measured by the first inverter 122, is reported to the modelling processor 110 for use by its constituent processing components.

The illustrated example further depicts a current combiner box C 154, which is depicted as being wired to receive and combine electrical current generated by the top two rows of the second solar array field 106, and a current combiner box D 156, which is depicted as being wired to receive and combine electrical current generated by the next two rows of the second solar array field 106. The ellipses beneath these components indicate that these components are replicated in various examples. The electrical current produced by the current combiner box C 154, current combiner box D 156, and further current combiner boxes (not shown) associated with the second solar array field 106 is provided to a second inverter 124 for conversion into electrical power suitable to additionally be provided to the electrical grid 160 in this example.

The example solar array and monitoring system 100 includes a modelling processor 110. The modelling processor 110 in an example receives measured data produced by the sensors within the first solar array field 104 and the second solar array field 106 in order to monitor and model the operations of those solar array fields. In this illustrated example, the modelling processor 110 includes a first model 112 and a second model 114. The first model 112 and the second model 114 are examples of predication models. The first model 112 receives monitored or measured values from sensors monitoring the first solar array field 104, and the second model 114 receives monitored or measured values from sensors monitoring the second solar array field 106.

The first model 112 in an example operates to provide estimations or predictions of the electrical power output of the first solar array field 104 based on the received monitored and measured data from the sensors of the first solar array field 104 and those received values. The second model 114 in an example receives monitored and measured data from the sensors of the second solar array field 106 and operates to provide estimations or predictions of the electrical power output of the second solar array field 106 based on those received values.

In some examples, processing within the modelling processor 110 determines if there are differences between the output power of one or both solar array fields that is predicted by one of the computer models and the actual power produced by that solar array field. In some examples, a particular computer model is able to be used to predict the electrical power output of either solar array field. For example, the output power of the first solar array field 104 is able to be predicted by the second computer model by appropriate scaling to account for differences between the capacities of these two solar array fields. In an example, the first computer model is refined based on determined differences between the output of the first model 112 and the second model 114 in order to improve the accuracy of the first computer model not withstanding its less dense arrangement of sensors. The refined first computer model is then able to be used in similar solar array fields, or areas being considered for potential solar array fields, to better predict the power output of those similar solar array fields or potential solar array fields.

The modelling processor 110 also includes a first model refinement processor 116. In various examples, the first model refinement processor 116 is a prediction model refinement processor that compares and analyzes processing and results between the operations of the first model 112 and the second model 114 to identify sources of errors between the output power predicted by the first model 112 and the output power predicted by the second model 114 that are due to the reduced sensor density between the number of sensors installed in the first solar array field 104 and the second solar array field 106. Based on these comparisons and analyses, the first model 112 is able to be modified, e.g., refined, to improve the accuracy of predicted power output produced by the first model 112 using the lower density of sensors available in the first solar array field 104.

In an example, the first model refinement processor 116 refines the first model 112 based on modelling of the second model 114 to improve estimations of electrical output produced by the first solar array field 104 by, at least in part, adjusting weights applied to values received from sensors associated with the first solar array field 104 to correct for errors caused by one or more operational characteristic of the solar farm 102 by adjusting the value of those weights to better conform to a refined estimated electrical output of the first solar array field 104 that is based on predictions provided by the second model 114. Such refinements may use, for example, extrapolations of predicted output power made by the second model to conform to the size of the first solar array field, processing of the measurements made by sensors associated with the first solar array field 104 by the second model 114, other techniques, or combinations of these. Operational characteristics that are able to cause errors for which the models are able to be refined include, but are not limited to, shading of cells by adjacent cells, tracking efficiency of tracking solar cells, amounts of output power that are below available output power—a phenomenon referred to as sub-curve, solar cell inefficiencies and DC power losses, impacts to output power due to environmental factors such as dirt/snow, etc., inefficiencies due to placement of bifacial solar cells.

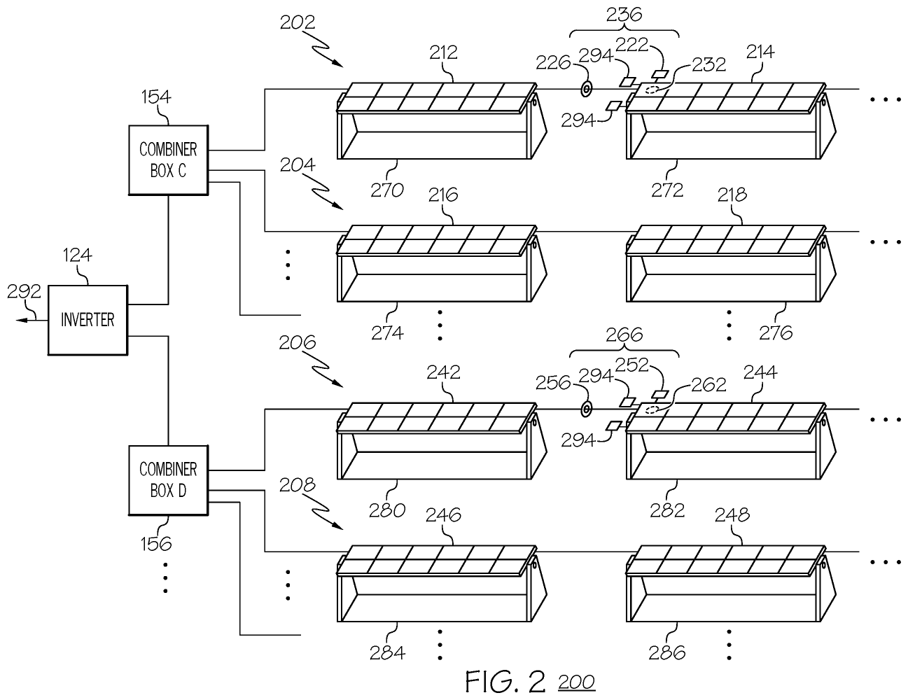

FIG. 2 illustrates a detailed view of the second solar array field and associated monitoring equipment 200, according to an example. The detailed view of the second solar array field and associated monitoring equipment 200 depicts a portion of the second solar array field 106, discussed above, along with the current combiner box C 154, and the current combiner box D 156. The detailed view of the second solar array field and associated monitoring equipment 200 shows only a portion of the second solar array field 106 in order to depict the aspects that are relevant to the following discussion.

The illustrated second solar array field 106 shows a portion of four (4) rows of solar cells, a first row 202, a second row 204, a third row 206, and a fourth row 208. Ellipses indicate that additional rows are present but not explicitly shown. In general, a second solar array field 106 is able to have any number of rows of solar cells, from one row up to any practical number. In further examples, cells are able to be placed in any arrangement aside from the depicted linear configuration.

Each illustrated row of solar cells depicts two racks that are able to hold a number of solar cells. The depicted example depicts a first row 202 with a first rack 212 that is mounted on a first pedestal 270 and a second rack 214 that is mounted on a second pedestal 272. Further depicted are a second row 204 with a third rack 216 mounted on a third pedestal 274 and a fourth rack 218 mounted on a fourth pedestal 276; a third row 206 with a fifth rack 242 mounted on a fifth pedestal 280 and a sixth rack 244 mounted on a sixth pedestal 282; and a fourth row 208 with a seventh rack 246 mounted on a seventh pedestal 284 and an eighth rack 248 mounted on an eighth pedestal 286. Each of these rows is able to have any number of racks as is shown by the ellipses.

In the depicted example, the electrical output of the first row 202 and the second row 204 are connected to the current combiner box C 154. The third row 206 and the fourth row 208 are connected to the current combiner box D 156. In general, each combiner box is able to receive electrical current from various numbers of rows of solar cells. As noted by the ellipses, further rows of solar cells, and further combiner boxes (not shown) are also able to be present.

The electrical current produced by the rows of solar cells is provided to the second inverter 124. The second inverter 124 in various examples operates to combine the electrical current produced by the rows of solar cells into a single electrical power output 292. The second inverter 124 in this example has an electrical current meter that measures the total electrical current produced by the second solar array field 106 and in an example reports those measurements to the modelling processor 110 discussed above.

Other sensors depicted by the detailed view of the second solar array field and associated monitoring equipment 200 include a number of reference cells 294 deployed around the site. In the illustrated example of a solar array field with tracking pedestals that are arranged in rows, two reference cells are mounted to the edges of one tracking table of alternating rows of pedestals onto which the solar cells are mounted. In the illustrated example, a respective reference cell 294 is mounted to each of a top edge and a bottom edge of the second rack 214 and the sixth rack 244. In some examples, the reference cells are mounted to the tracker table top cause them to have the same tilt and plane of array irradiance as the solar cells. In some examples, for both tilting and fixed tilt installations, the reference cells are installed so as to be parallel to the surface of the table or other structure to which the solar cells are mounted. In an example of such a tracking array, the reference cells will move with the tacker throughout the day so that they are oriented so as to be parallel with the same tilt as the solar cell modules.

The detailed view of the second solar array field and associated monitoring equipment 200 further depicts some of the sensors deployed round the second solar array field 106. A first Back of Module (BOM) temperature sensor 232 and a first rack inclinometer 222 are shown to be attached to the second rack 214. A second BOM temperature sensor 262 and a second rack inclinometer 252 are attached to the sixth rack 244. The first row of solar cells 202 also has a first current transformer 226 installed between the first rack 212 and the second rack 214, and the third row of solar cells 206 a second current transformer 256 mounted between the fifth rack 242 and the sixth rack 244. The first current transformer 226 and the second current transformer 256 are examples of current sensors that measure and report the electrical current produced by the row of solar cells on which it is installed.

In the illustrated example, the detailed view of the second solar array field and associated monitoring equipment 200 depicts that some monitoring equipment are installed in a multiple instrument cluster. For example, a first multi-instrument cluster 236 includes two references cells 294 that are attached to the second rack 214, the first BOM temperature sensor 232 the first inclinometer 222, and the first current transformer 226. A second multi-instrument cluster 266 includes two references cells 294 that are attached to the sixth rack 244, the second BOM temperature sensor 262 the second rack inclinometer 252, and the second current transformer 256. In the illustrated example, such multi-instrument clusters are installed in every other row of solar cells. In further examples, multi-instrument clusters that comprise any combination of monitoring equipment are able to be installed with any suitable density within a solar array field, such as one on every row, with one installed at periodic intervals throughout the solar array field, with installations of multi-instrument clusters distributed irregularly, e.g., at unequal distances from one another, with any distribution, or with distributions that consist of any combination of these. In some examples, one or more instruments are able to be distributed in the second solar array field with a density of one installation of one or more of these instruments every 0.001 square Kilometer. In the following discussion, such distributions of monitoring equipment correspond to respective instances of monitoring equipment being associated with selected solar cells. Such associations with selected solar cells is able to correspond to any type of association, such as being mounted to the selected solar cells, mounted near the selected solar cells, any other type of association, or combinations of these.

The density of the illustrated sensors is an example provided to explain relevant aspects of this example. Further densities of sensors are able to be deployed. In addition to the sensors illustrated within the detailed view of the second solar array field 106 and associated monitoring equipment 200, other sensors, additional types of sensors, or combinations of these, are able to be deployed as is described in further detail below.

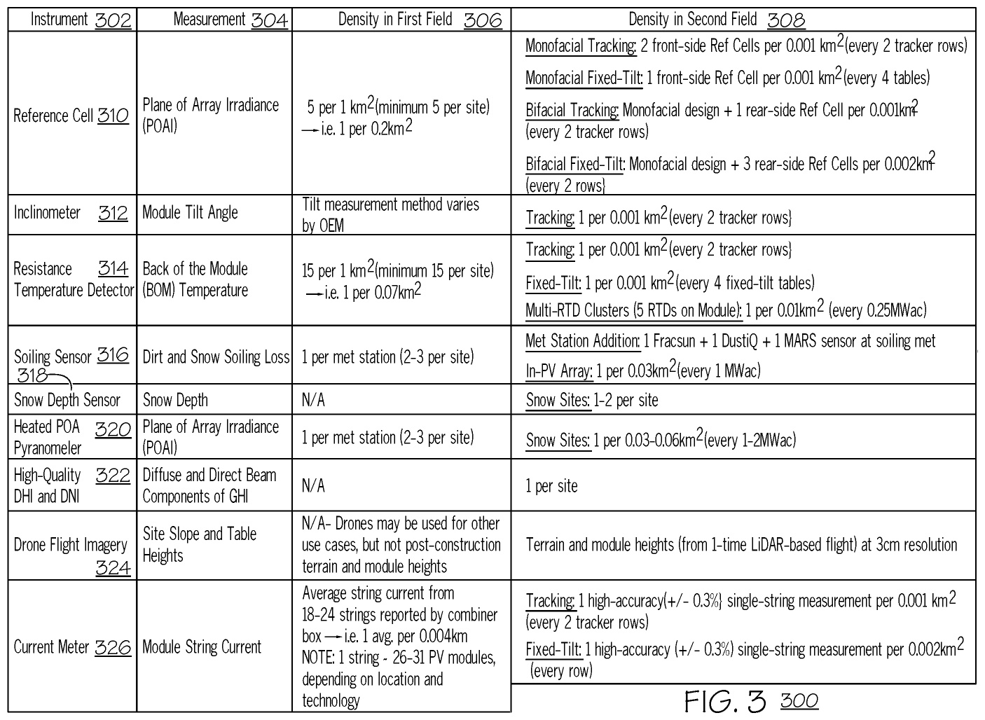

FIG. 3 illustrates a sensor equipment density chart 300, according to an example. The sensor equipment density chart 300 illustrates an example of densities of various types of monitoring sensor equipment that is installed in two types of solar array farms. The illustrated sensor equipment density chart 300 depicts the density of monitoring sensor equipment that is installed in each of the above described first solar array field 104 and the second solar array field 106 that make up the solar array 102. The sensor equipment density chart 300 has one row for each type of instrument that is deployed into the solar array 102. The densities in the sensor equipment density chart 300 are an example of densities of sensors in an example configuration of a first solar array field 104 and a second solar array field 106. It is to be understood that further examples are able to have different densities of one or more of the listed measurement sensors. It is further to be understood that further examples are able to have only a subset of the sensors listed in the sensor equipment density chart 300, or have additional sensors with ratios between the first solar array field 104 and second solar array field 106 determined by the designs of the algorithms used to process these measurements produced by those measurement sensors.

The sensor equipment density chart 300 includes an instrument column 302 that specifies the type of instrument for which each row contains information. A measurement column 304 describes the type of measurement the instrument in that row performs. A density in first field column 306 describes the density of the distribution of the various measurement sensors in the first solar array field 104, with the value in that column indicating the density of the measurement sensor in that row. A density in second field column 308 describes the density of the distribution of the various measurement sensors in the second solar array field 106, with the value in that column indicating the density of the measurement sensor in that row.

A reference cell row 310 describes the measurement and distributions of a solar energy irradiance reference cell that is used to measure the incident irradiance from the sun onto the face of a solar cell. The density in second field column 308 for the reference cell row 310 indicates different densities for solar array fields that have different types of solar cell equipment.

An inclinometer row 312 describes the distribution of inclinometers that measure the incline, or tilt angle, of a solar cell module to which it is attached, and notes that the distribution of these sensors are specified by OEMs in the first solar array field. A resistance temperature detector row 314 describes the distribution of back of module (BOM) temperature sensors in the second solar array field 106 and notes that the distribution of these sensors in the first solar array field is generally 15 per square kilometer, with a minimum of 15 per site. In general, the distribution of BOM temperature sensors in an example has a density of one per 0.07 square kilometers.

The sensor equipment density chart 300 includes a soiling sensor row 316 that describes the distribution of soiling sensors that measure the amount of solar energy loss that is due to dirt or snow accumulating on the solar cell surfaces. In various examples, soiling sensors are able to be mounted on a front side of a solar panel, or on a rear side of a solar panel. In some examples, a solar panel is able to have a soiling sensor on both its front side and its back side. A snow depth sensor row 318 describes the number of snow depth sensors present in the second solar array field 106 and notes that these sensors are not present in the first solar array field 104.

A heated Plane Of Array (POA) pyranometer row 320 describes the density of measurement sensors in the second solar array field 106 that measure the amount of solar radiation, at the angle of the plane of the solar cell that reaches the pyranometer. The heated Plane Of Array (POA) pyranometer row 320 notes that the first solar array field 104 has 2 to 3 such measurement sensors.

The High-Quality DHI and DNI row 322 describes that the second solar array field 106 has one such measurement device that measures the diffuse and direct beam components of Global Horizontal Irradiance (GHI) by measuring: 1) the Direct Normal Irradiance (DNI) that indicates an amount of solar radiation received per unit area by a surface that is perpendicular (or normal) to the rays that come in a straight line from the direction of the sun at the sun's current position in the sky; and 2) the Diffuse Horizontal Irradiance (DHI) that is the total amount of diffuse, e.g., indirect, diffused sunlight received by a surface horizontal to the ground.

A drone flight imagery row 324 indicates that drone captured measurements are able to be used to determine relative heights, e.g., differences in elevation above sea level, of the ground terrain, solar modules, or both, as they are installed in the second solar array field 106 and that such measurements are not generally captured for the first solar array field 104. In an example, drone flight imagery is also able to include infrared images captured by an infrared camera in order to provide an additional monitoring technique for monitoring solar cell temperature. The current meter row 326 indicates the distribution of electrical current measurement devices that measure the electrical current for a string of solar cells. The density in second field column 308 for the current meter row 326 indicates different densities for solar array fields that have different types of solar cell equipment.

In an example, the equipment density depicted in the sensor equipment density chart 300 is able to be deployed by including a number of those sensors in a multi-instrument cluster. In such an example, a number of multi-instrument clusters are located at variable locations within the second solar array field. In the illustrated example, a first multi-instrument cluster 236 and a second multi-instrument cluster 266 are positioned at locations similar to the locations within the solar array field at which the reference cells 294 are located, e.g., with one such multi-instrument cluster located every two rows across the second solar array field. In such an example, as described above, each multi-instrument cluster is able to include one resistance temperature sensor, one inclinometer, and one current sensor such as a current transformer. In an example with tracking solar cells, each multi-instrument cluster has two reference cells 294, with one at the top edge of a mounting table and the other at the bottom edge of the mounting table. In an example with fixed tilt solar cells, each high-density instrument cluster has one reference cell.

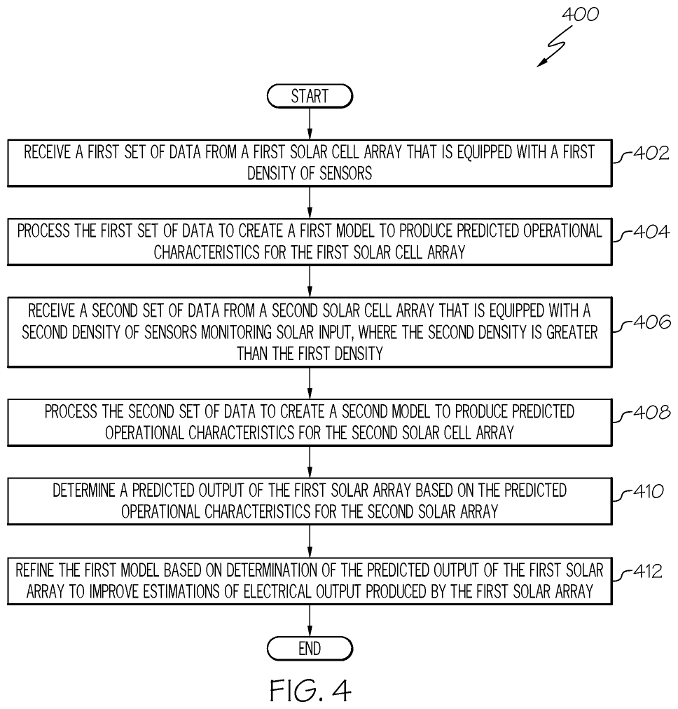

FIG. 4 illustrates a solar array model improvement process 400, according to an example. The solar array model improvement process 400 is an example of a process performed at least in part by the above-described modelling processor 110. The solar array model improvement process 400 is an example of processing that is used to improve the accuracy of the first model 112 based on the processing of the second model 114. In this example, the processing of the second model 114 is presumed to be more accurate due to the higher density of sensors located within the second solar array field 106. In an example where the first solar array field 104 and the second solar array field 106 are located in similar areas with similar solar irradiation and environmental characteristics, an accurate prediction of the output of the first solar array field 104 is assumed to be realized by an extrapolation of the predictions made by the second model 114 to account for the larger number of solar cells present in the first solar array field 104.

The solar array model improvement process 400 receives, at 402, a first set of data from a first solar cell array that is equipped with a first density of sensors. Data within the first set of data is processed, at 404, to create a first model to produce predicted operational characteristics for the first solar cell array. With reference to the above-described example, an example of this is the first model 112 receiving data from sensors in the first solar array field 104.

A second set of data is received, at 406, from a second solar cell array that is equipped with a second density of sensors monitoring solar input, where the second density is greater than the first density. Data within the second set of data is processed, at 408, to create a second model to produce predicted operational characteristics for the second solar cell array. With reference to the above-described example, an example of this is the second model 114 receiving data from sensors in the second solar array field 106.

A predicted output of the first solar array is predicted, at 410, based on the predicted operational characteristics for the second solar array. The first model is refined, at 412, based on determination of the predicted output of the first solar array to improve estimations of electrical output produced by the first solar array. With reference to the above-described example, this is performed by the first model refinement processor 116. The solar array model improvement process 400 then ends.

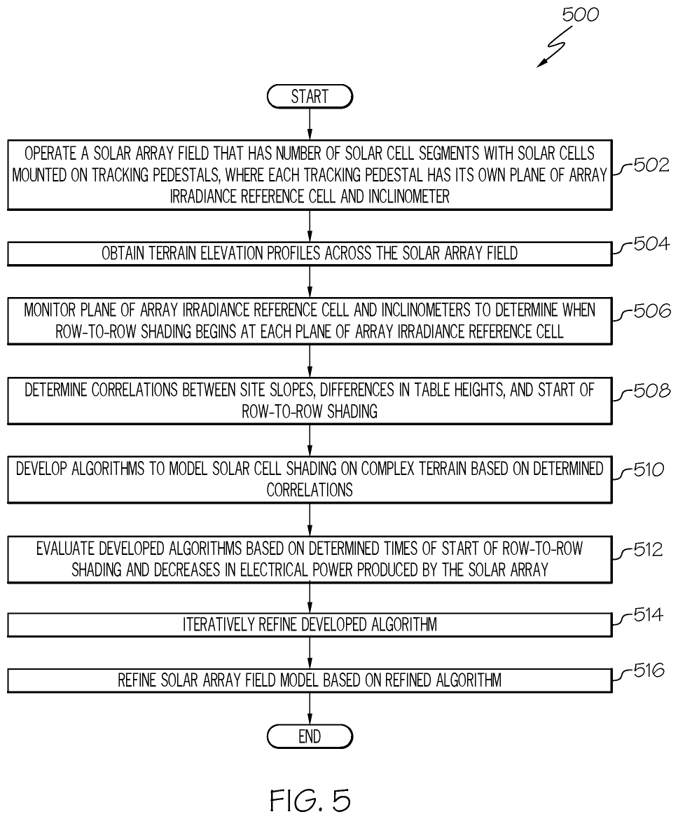

FIG. 5 illustrates a tracking pedestal shading determination algorithm 500, according to an example. The tracking pedestal shading determination algorithm 500 is an example of processing performed by the shading processor 118 discussed above. In an example, the tracking pedestal shading determination algorithm 500 operates across the solar array 102 described above where the solar array 102 includes tracking solar cell pedestals that operate to cause the solar cells to track the sun as it moves across the sky and move the solar cells so as to be close to a perpendicular relationship with the arriving solar energy.

The tracking pedestal shading determination algorithm 500 operates, at 502, a solar array field that has number of solar cell segments with solar cells mounted on tracking pedestals. In an example, each tracking pedestal has its own plane of array irradiance reference cell and inclinometer. In various examples, the solar cells are able to be mono-facial, in which solar energy is collected on only one side of the solar cell, or bifacial, in which solar energy is collected on both sides of the solar cell.

Terrain elevation profiles are determined, at 504, across the solar array field. In some examples, terrain elevation profiles include, but are not limited to, site slopes and differences in table heights. In an example, such terrain elevation profiles are determined based upon aerial measurements, such as measurements made via various techniques from a drone or aircraft flying over the solar array field.

Plane of array irradiance reference cells, inclinometers, and current transformers are monitored, at 506. These sensors in an example are monitored in the first solar array field 104 and the second solar array field 106. The plane of array irradiance reference cells, inclinometers, and current transformers are monitored to determine when row-to-row shading begins at each plane of array irradiance reference cell.

Correlations are determined, at 508, between site slopes, differences in table heights, and start of row-to-row shading. Algorithms are developed, at 510, to model solar cell shading on complex terrain based on determined correlations. The developed algorithms are evaluated, at 512, based on determined times of start of row-to-row shading and decreases in electrical power produced by the solar array. The developed algorithms are iteratively refined, at 514. A solar array field shading model is refined, at 516, based on refined algorithm. The tracking pedestal shading determination algorithm 500 then ends.

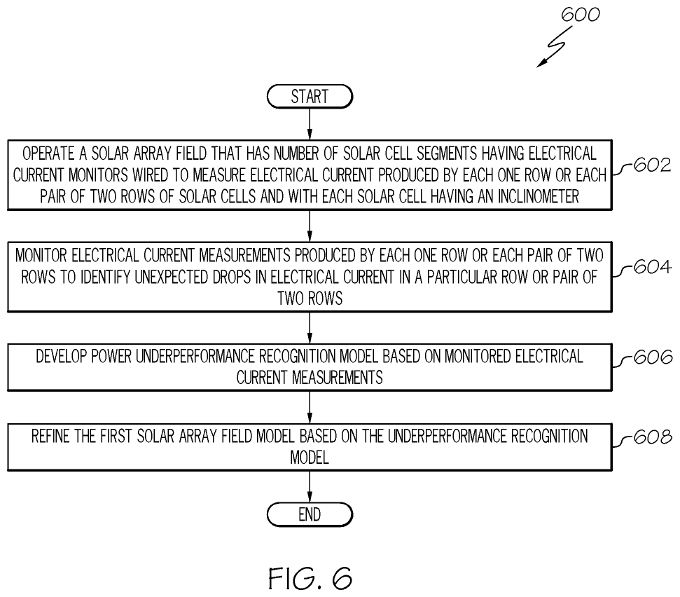

FIG. 6 illustrates a solar farm underperformance recognition model development process 600, according to an example. The solar farm underperformance recognition model development process 600 is an example of processing performed by the underperformance recognition processor 130, discussed above, in conjunction with the first model refinement processor 116. In an example, the solar farm underperformance recognition model development process 600 operates across the solar array 102 described above to identify an amount of DC output power underperformance of the solar array based on differences between modeled and measured electrical currents.

The solar farm underperformance recognition model development process 600 operates a solar array field, at 602, that has number of solar cell segments having electrical current monitors wired to measure electrical current produced by, for example, selected rows of solar cells where some solar cells have an attached or associated inclinometer.

Electrical current measurements produced by each one row or each pair of two rows are monitored, at 604, to identify unexpected drops in electrical current in a particular row or pair of two rows. A power underperformance recognition model is developed, at 606, based on monitored electrical current measurements.

The first solar array field model is refined, at 608, based on the underperformance recognition model. In an example, common indications of reduced electrical current outputs between the first model 112 and the second model 114 are detected and analyzed by the first model refinement processor 116 in order to refine the first model 112 based on observations made to the second model. This refinement operates to correct for errors in modelling DC underperformance of solar farms. The solar farm underperformance recognition model development process 600 then ends.

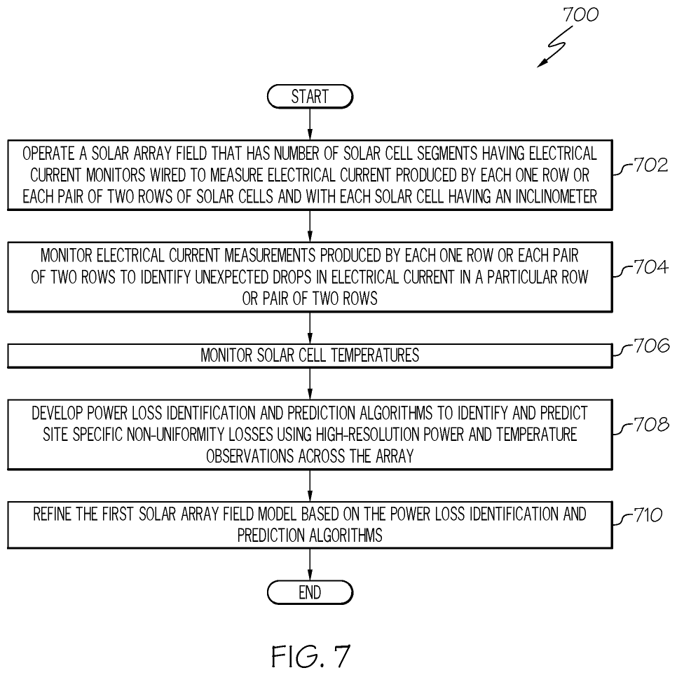

FIG. 7 illustrates a solar farm temperature dependence model adjustment process 700, according to an example. The solar farm temperature dependence model adjustment process 700 is an example of processing performed by the temperature dependence model processor 132, discussed above, in conjunction with the first model refinement processor 116. In an example, the solar farm temperature dependence model adjustment process 700 operates across the solar array 102 described above.

The solar farm temperature dependence model adjustment process 700 operates a solar array field, at 702, that has number of solar cell segments having electrical current monitors wired to measure electrical current produced by selected rows of solar cells, where in an example selected solar cells have a respective resistance temperature detector (RTD), and where the inclination of such solar cells in a tracking solar array is measured by an inclinometer associated with that solar cell. With reference to the above described first rack 212, the inclination of solar cells in the first rack 212 are all measured by the first rack inclinometer 222 attached to the first rack 212. In an example, further solar cell temperature data is able to be obtained by one or more infrared camera that captures infrared images of the solar cells. Such infrared cameras are able to be mounted on structures near the solar cells, on airborne platforms such as drones, located by other techniques, or combinations of these.

Electrical current measurements produced by each one row or each pair of two rows of the second solar array field 106 are monitored, at 704, to identify unexpected drops in electrical current in a particular row or pair of two rows. Solar cell temperatures of the second solar array field 106 are monitored, at 706. Power loss identification and prediction algorithms are developed, at 708, to identify and predict site-specific non-uniformity losses using high-resolution power and temperature observations across the array. The first solar array field model for the first solar array field 104 is refined, at 710, based on the power loss identification and prediction algorithms. In an example, the temperature dependence model processor 132 operates with the first model refinement processor 116 to refine the first model. The solar farm temperature dependence model adjustment process 700 then ends.

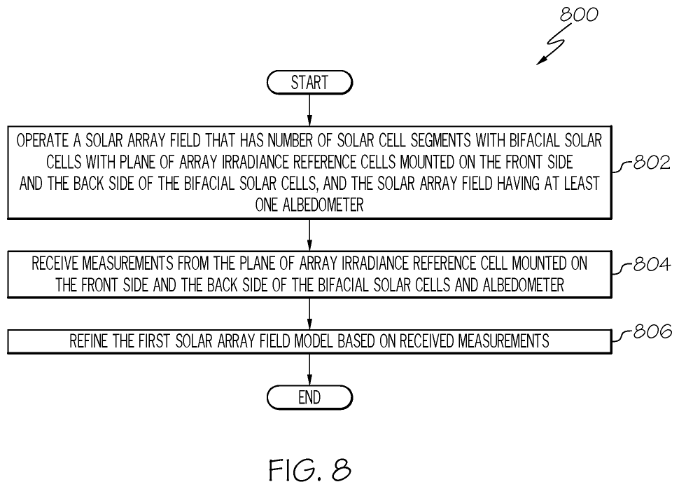

FIG. 8 illustrates a bifacial array solar farm estimation model development process 800, according to an example. The bifacial array solar farm estimation model development process 800 is an example of processing performed by the bifacial estimation processor 134, discussed above. In an example, the Bifacial array solar farm estimation model development process 800 operates across the solar array 102 described above.

The Bifacial array solar farm estimation model development process 800 operates a solar array field, at 802, that has number of solar cell segments with Bifacial solar cells with plane of array irradiance reference cells mounted on the front side and the back side of the Bifacial solar cells, and the solar array field having at least one Albedometer that monitors ground surface reflectance in a vicinity of solar cells in the solar array field. In an example, the second solar array field described above is operated in such a manner. Measurements are received, at 804, from the plane of array irradiance reference cell mounted on the front side and the back side of the Bifacial solar cells and albedometer. A solar array field model is refined, at 806, based on received measurements. In an example, the second model 114 is refined, and the model refinement further includes refining the first model for the first solar array field 104 based on the refinements to the second model 114. The Bifacial array solar farm estimation model development process 800 then ends.

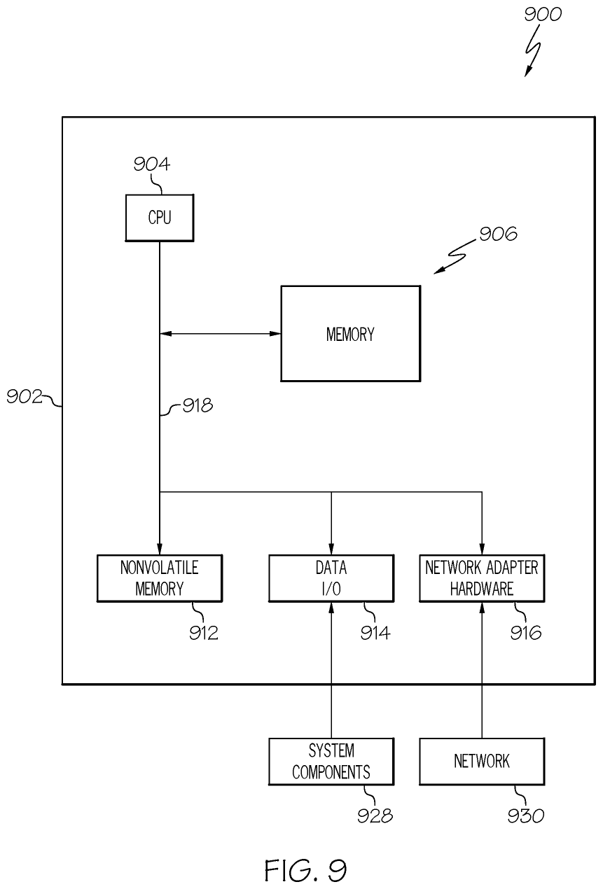

FIG. 9 illustrates a block diagram illustrating a processor 900 according to an example. The processor 900 is an example of a processing subsystem that is able to perform any of the above-described processing operations, control operations, other operations, or combinations of these.

The processor 900 in this example includes a CPU 904 that is communicatively connected to a main memory 906 (e.g., volatile memory), a non-volatile memory 912 to support processing operations. The CPU is further communicatively coupled to a network adapter hardware 916 to support input and output communications with external computing systems such as through the illustrated network 930.

The processor 900 further includes a data input/output (I/O) processor 914 that is able to be adapted to communicate with any type of equipment, such as the illustrated system components 928. The data input/output (I/O) processor in various examples is able to be configured to support any type of data communications connections including present day analog and/or digital techniques or via a future communications mechanism. A system bus 918 interconnects these system components.

### Information Processing System

The present subject matter can be realized in hardware, software, or a combination of hardware and software. A system can be realized in a centralized fashion in one computer system, or in a distributed fashion where different elements are spread across several interconnected computer systems. Any kind of computer system-or other apparatus adapted for carrying out the methods described herein-is suitable. A typical combination of hardware and software could be a general purpose computer system with a computer program that, when being loaded and executed, controls the computer system such that it carries out the methods described herein.

The present subject matter can also be embedded in a computer program product, which comprises all the features enabling the implementation of the methods described herein, and which-when loaded in a computer system-is able to carry out these methods. Computer program in the present context means any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory, CD-ROM, and other permanent storage. Additionally, a computer medium may include volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information. In general, the computer readable medium embodies a computer program product as a computer readable storage medium that embodies computer readable program code with instructions to control a machine to perform the above-described methods and realize the above-described systems.

### Non-Limiting Examples

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

1. A computer-implemented method for training a power production estimating system, comprising:
collecting a first set of sensor data from a first solar array field comprising a first plurality of solar cell segments, where each solar cell segment in the first plurality of solar cell segments comprises an associated first plurality of sensors and comprises an area greater than a first area size;
collecting a second set of sensor data from a second solar array field comprising a second plurality of solar cell segments, where each solar cell segment in the second plurality of solar cell segments comprises an associated second plurality of sensors and comprises an area less than a second area size, wherein the first area size is at least three times the second area size;
creating a first training set from the first set of sensor data;
developing a prediction model that provides estimations of electrical output produced by the first solar array field based on the first training set;
creating a second training set from the second set of sensor data; and
refining the prediction model that provides estimations of electrical output produced by the first solar array field, the refining based on modelling of the second solar array field using the second training set to improve estimations of electrical output produced by the first solar array field, the refining comprising adjusting weights applied to values received from the first plurality of sensors to conform to a refined estimated electrical output determined based on the second training set.

2. The method of claim 1, wherein the second solar array field is within the first solar array field.

3. The method of claim 1, wherein the first plurality of solar cell segments and the second plurality of solar cell segments comprise mono-facial, tracking solar cells,
wherein solar cells in the first plurality of solar cell segments are mounted on respective tracking pedestals within a first plurality of tracking pedestals,
wherein solar cells in the second plurality of solar cell segments are mounted on respective tracking pedestals within a second plurality of tracking pedestals, where the second plurality of tracking pedestals are arranged in rows,
wherein refining the prediction model comprises refining the prediction model to correct for errors caused by one of shading of the solar cells or tracking efficiency of the solar cells in the first solar array field, and wherein the second plurality of sensors comprises:
at least one plane of array irradiance reference cell located associated with each tracking pedestal within the second plurality of tracking pedestals;
at least one respective inclinometer that is installed in at least every other row of tracking pedestals within the second plurality of tracking pedestals, the at least one respective inclinometer each measuring a respective incline of a respective tracking solar cell; and
a respective current sensor installed in each row or every other row of solar cells mounted on fixed-tilt pedestals within the second plurality of solar cell segments, each respective current sensor monitoring electrical current produced by its respective row of solar cells.

4. The method of claim 1, wherein the first solar array field and the second solar array field comprise mono-facial fixed-tilt solar cells mounted on fixed-tilt pedestals,
wherein refining the prediction model comprises refining the prediction model to correct for errors in shading of solar cells in the first solar array field, and wherein the second plurality of sensors comprises:
at least one plane of array irradiance reference cell located associated with each fixed-tilt pedestal; and
a respective current sensor installed in each row or every other row of solar cells mounted on fixed-tilt pedestals within the second plurality of solar cell segments, each respective current sensor monitoring electrical current produced by its respective row of solar cells.

5. The method of claim 1, wherein refining the prediction model comprises refining the prediction model to correct for errors in modelling DC underperformance of the first solar array field, and wherein the second plurality of sensors comprises:
a current sensor monitoring electrical current through a combiner box of the second plurality of solar cell segments; and
a respective current sensor installed in each row or every other row of solar cells mounted on fixed-tilt pedestals within the second plurality of solar cell segments, each respective current sensor monitoring electrical current produced by its respective row of solar cells.

6. The method of claim 1, wherein the first plurality of solar cell segments and the second plurality of solar cell segments comprise tracking solar cells, and
wherein the second plurality of sensors further comprises at least one inclinometer per each 0.001 square Kilometers, the at least one inclinometer each measuring a respective incline of a respective tracking solar cell.

7. The method of claim 1, wherein refining the prediction model comprises refining the prediction model to correct for errors in one of PV Efficiency or DC power Losses of the first solar array field, and wherein the second plurality of sensors comprises:
at least one infrared camera capturing infrared images of surfaces of solar cells within the second plurality of solar cell segments;
a respective back of module temperature sensor for selected solar cells in the second plurality of solar cell segments; and
a respective current sensor installed in each row or every other row of solar cells mounted on fixed-tilt pedestals within the second plurality of solar cell segments, each respective current sensor monitoring electrical current produced by its respective row of solar cells.

8. The method of claim 1, wherein the first solar array field and the second solar array field comprise bifacial solar cells, and wherein refining the prediction model comprises refining the prediction model to correct for errors in power output of bifacial solar cells of the first solar array field, and wherein the second plurality of sensors comprises:
at least one plane of array irradiance reference cell located associated with a back side of selected solar cells in the second plurality of solar cell segments;
at least one rear side soiling sensor monitoring soiling on a rear side of solar cell within the second plurality of solar cell segments; and
at least one albedometer monitoring ground surface reflectance in a vicinity of the second plurality of solar cell segments.

9. The method of claim 1, wherein the first area size is at least 0.2 square Kilometers, and the second area size is less than 0.06 square Kilometers.

10. A power production estimation model training system, comprising:
a first solar array field comprising a first plurality of solar cell segments, where each solar cell segment in the first plurality of solar cell segments comprises an associated first plurality of sensors and comprises an area greater than a first area size;
a second solar array field comprising a second plurality of solar cell segments, where each solar cell segment in the second plurality of solar cell segments comprises an associated second plurality of sensors and comprises an area less than a second area size, wherein the first area size is at least three times the second area size;
a processor;
a memory communicatively coupled to the processor;
a first modelling processor configured to, when operating:
collect a first set of sensor data from the first solar array field;
create a first training set from the first set of sensor data;
develop a prediction model that provides estimations of electrical output produced by the first solar array field based on the first training set;
a second modelling processor configured to, when operating:
collect a second set of sensor data from the second solar array field;
create a second training set from the second set of sensor data; and
a prediction model refinement processor that, when operating, refines the prediction model that provides estimations of electrical output produced by the first solar array field, the refining based on modelling of the second solar array field using the second training set to improve estimations of electrical output produced by the first solar array field, wherein the prediction model refinement processor refines by at least adjusting weights applied to values received from the first plurality of sensors to conform to a refined estimated electrical output provided by the second training set.

11. The power production estimation model training system of claim 10, wherein the second solar array field is within the first solar array field.

12. The power production estimation model training system of claim 10, wherein the first plurality of solar cell segments and the second plurality of solar cell segments comprise mono-facial, tracking solar cells,
wherein solar cells in the first plurality of solar cell segments are mounted on respective tracking pedestals within a first plurality of tracking pedestals,
wherein solar cells in the second plurality of solar cell segments are mounted on respective tracking pedestals within a second plurality of tracking pedestals, where the second plurality of tracking pedestals are arranged in rows,
wherein the prediction model refinement processor, when operating, refines the prediction model by at least refining the prediction model to correct for errors caused by one of shading of the solar cells or tracking efficiency of the solar cells in the first solar array field, and wherein the second plurality of sensors comprises:
at least one plane of array irradiance reference cell located associated with each tracking pedestal within the second plurality of tracking pedestals;
at least one respective inclinometer that is installed in at least every other row of tracking pedestals within the second plurality of tracking pedestals, the at least one respective inclinometer each measuring a respective incline of a respective tracking solar cell; and
a respective current sensor installed in each row or every other row of solar cells mounted on fixed-tilt pedestals within the second plurality of solar cell segments, each respective current sensor monitoring electrical current produced by its respective row of solar cells.

13. The power production estimation model training system of claim 10, wherein the first solar array field and the second solar array field comprise mono-facial fixed-tilt solar cells mounted on fixed-tilt pedestals,
wherein the prediction model refinement processor, when operating, refines the prediction model by at least refining the prediction model to correct for errors in shading of solar cells in the first solar array field, and wherein the second plurality of sensors comprises:
at least one plane of array irradiance reference cell located associated with each fixed-tilt pedestal; and
a respective current sensor installed in each row or every other row of solar cells mounted on fixed-tilt pedestals within the second plurality of solar cell segments, each respective current sensor monitoring electrical current produced by its respective row of solar cells.

14. The power production estimation model training system of claim 10, wherein the prediction model refinement processor, when operating, refines the prediction model by at least refining the prediction model to correct for errors in modelling DC underperformance of the first solar array field, and wherein the second plurality of sensors comprises:
a current sensor monitoring electrical current through a combiner box of the second plurality of solar cell segments; and
a respective current sensor installed in each row or every other row of solar cells mounted on fixed-tilt pedestals within the second plurality of solar cell segments, each respective current sensor monitoring electrical current produced by its respective row of solar cells.

15. The power production estimation model training system of claim 14, wherein the first plurality of solar cell segments and the second plurality of solar cell segments comprise tracking solar cells, and
wherein the second plurality of sensors further comprises at least one inclinometer per each 0.001 square Kilometers, the at least one inclinometer each measuring a respective incline of a respective tracking solar cell.

16. The power production estimation model training system of claim 10, wherein the prediction model refinement processor, when operating, refines the prediction model by at least refining the prediction model to correct for errors in one of PV Efficiency or DC power Losses of the first solar array field, and wherein the second plurality of sensors comprises:
at least one infrared camera capturing infrared images of surfaces of solar cells within the second plurality of solar cell segments;
a respective back of module temperature sensor for selected solar cells in the second plurality of solar cell segments; and
a respective current sensor associated with selected solar cells within the second plurality of solar cell segments; and
a respective current sensor installed in each row or every other row of solar cells mounted on fixed-tilt pedestals within the second plurality of solar cell segments, each respective current sensor monitoring electrical current produced by its respective row of solar cells.

17. The power production estimation model training system of claim 10, wherein the first solar array field and the second solar array field comprise bifacial solar cells, and wherein the prediction model refinement processor, when operating, refines the prediction model by at least refining the prediction model to correct for errors in power output of bifacial solar cells of the first solar array field, and wherein the second plurality of sensors comprises:
at least one plane of array irradiance reference cell located associated with a back side of selected solar cells in the second plurality of solar cell segments;
at least one rear side soiling sensor monitoring soiling on a rear side of selected solar cells within the second plurality of solar cell segments; and
at least one albedometer monitoring ground surface reflectance in a vicinity of the second plurality of solar cell segments.

18. A computer program product training a power production estimating system, the computer program product comprising:
a non-transitory computer readable storage medium having computer readable program code embodied therewith, the computer readable program code comprising instructions for:
collecting a first set of sensor data from a first solar array field comprising a first plurality of solar cell segments, where each solar cell segment in the first plurality of solar cell segments comprises an associated first plurality of sensors and comprises an area of solar cells greater than a first area size;
collecting a second set of sensor data from a second solar array field comprising a second plurality of solar cell segments, where each solar cell segment in the second plurality of solar cell segments comprises an associated second plurality of sensors and comprises an area of solar cells less than a second area size, wherein the first area size is at least three times the second area size;
creating a first training set from the first set of sensor data;
developing a prediction model that provides estimations of electrical output produced by the first solar array field based on the first training set;
creating a second training set from the second set of sensor data; and
refining the prediction model that provides estimations of electrical output produced by the first solar array field, the refining based on modelling of the second solar array field using the second training set to improve estimations of electrical output produced by the first solar array field, the refining comprising adjusting weights applied to values received from the first plurality of sensors to conform to a refined estimated electrical output provided by the second training set.

19. The computer program product of claim 18, wherein the first solar array field and the second solar array field comprise mono-facial fixed-tilt solar cells mounted on fixed-tilt pedestals,
wherein the instructions for refining the prediction model comprise instructions for refining the prediction model to correct for errors in shading of solar cells in the first solar array field, and wherein the second plurality of sensors comprises:
at least one plane of array irradiance reference cell located associated with each fixed-tilt pedestal; and
a respective current sensor installed in each row or every other row of solar cells mounted on fixed-tilt pedestals within the second plurality of solar cell segments, each respective current sensor monitoring electrical current produced by its respective row of solar cells.

20. The computer program product of claim 18, wherein the instructions for refining the prediction model comprise instructions for refining the prediction model to correct for errors in one of PV Efficiency or DC power Losses of the first solar array field, and wherein the second plurality of sensors comprises:
at least one infrared camera capturing infrared images of surfaces of solar cells within the second plurality of solar cell segments;
a respective back of module temperature sensor for selected solar cells in the second plurality of solar cell segments; and
a respective current sensor installed in each row or every other row of solar cells mounted on fixed-tilt pedestals within the second plurality of solar cell segments, each respective current sensor monitoring electrical current produced by its respective row of solar cells.
